(19) United States
(12) Patent Application Publication
(10) Pub. No.: US 2026/0120710 A1
(43) Pub. Date: Apr. 30, 2026

(54) FILTERING EXTRANEOUS VOICES FROM COMMUNICATION SESSIONS

(71) Applicant: Avaya Management L.P., Morristown, NJ (US)

(72) Inventors: Paul Roller Michaelis, Louisville, CO (US); Sudhir Nivrutti Shelke, Pune (IN); Amol Manik Navale, Pune (IN); Shailendra Pratap Singh, Pune (IN)

(21) Appl. No.: 18/931,035

(22) Filed: Oct. 29, 2024

(51) Int. Cl. G10L 25/51; G10L 17/26; G10L 25/78

(52) U.S. Cl. CPC G10L 25/51; G10L 17/26; G10L 25/78; G10L 2025/783

(57) ABSTRACT

A system, device, and method for filtering extraneous voices from a communication session that includes receiving, via a microphone of a communication device, an audio stream associated with a communication session, wherein the audio stream is stored in a first-in, first-out (FIFO) buffer. The method further includes processing the audio stream from the FIFO buffer to generate a filtered audio stream where a voice of a user associated with the communication device is retained and voices other than the voice of the user associated with the communication device are removed. The method also includes transferring the filtered audio stream to another party of the communication session.

### FIELD

The present disclosure relates generally to systems and methods for communication sessions and particularly relates to systems and methods for filtering extraneous voices from communication sessions.

### BACKGROUND

Commercial enterprises frequently use contact centers to provide information, such as technical support information, to customers. A caller may dial a telephone number associated with a manufacturer of a product, answer certain questions posed by an interactive voice response system, and then be routed to a particular contact center agent based on the caller's answers. The contact center agent begins a dialog with the caller. Contact center agents may be seated near each other such that the voice of one contact center agent may be overheard by the customer speaking with another contact center agent.

Therefore, there is a need for systems and methods for filtering/removing voices other than the voice of the contact center agent associated with that specific communication session.

### SUMMARY

These and other needs are addressed by the various embodiments and configurations of the present disclosure. The present disclosure can provide a number of advantages depending on the particular configuration. These and other advantages will be apparent from the disclosure contained therein.

The phrases “at least one”, “one or more”, and “and/or” are open-ended expressions that are both conjunctive and disjunctive in operation. For example, each of the expressions “at least one of A, B and C”, “at least one of A, B or C”, “one or more of A, B and C”, “one or more of A, B or C” and “A, B and/or C” means A alone, B alone, C alone, A and B together, A and C together, B and C together or A, B and C together.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The term “automatic” and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

The term “communication session” as used herein refers to any communication or set of communications, whether including audio, video, text or other multimedia data, between two or more communication endpoints and/or users. Typically, a conference includes two or more communication endpoints. The terms “conference” and “conference call” are used interchangeably throughout the specification.

The term “communication device” or “communication endpoint” as used herein refers to any hardware device and/or software operable to engage in a communication session. For example, a communication device can be an Internet Protocol (IP)-enabled phone, a desktop phone, a cellular phone, a personal digital assistant, a soft-client telephone program executing on a computer system, etc. IP-capable hard- or softphone can be modified to perform the operations according to embodiments of the present disclosure.

The term “network” as used herein refers to a system used by one or more users to communicate. The network can consist of one or more session managers, feature servers, communication endpoints, etc. that allow communications, whether voice or data, between two users. A network can be any network or communication system as described in conjunction with FIG. 1. Generally, a network can be a Local Area Network (LAN), a Wide Area Network (WAN), a wireless LAN, a wireless WAN, the Internet, etc. that receives and transmits messages or data between devices. A network may communicate in any format or protocol known in the art, such as, Transmission Control Protocol/IP (TCP/IP), 802.11g, 802.11n, Bluetooth or other formats or protocols.

The term “communication event” and its inflected forms includes: (i) a voice communication event, including but not limited to a voice telephone call or session, the event being in a voice media format or (ii) a visual communication event, the event being in a video media format or an image-based media format or (iii) a textual communication event, including but not limited to instant messaging, internet relay chat, e-mail, short-message-service, Usenet-like postings, etc., the event being in a text media format or (iv) any combination of (i), (ii), and (iii).

The term “communication system” or “communication network” and variations thereof, as used herein, can refer to a collection of communication components capable of one or more of transmission, relay, interconnect, control or otherwise manipulate information or data from at least one transmitter to at least one receiver. As such, the communication may include a range of systems supporting point-to-point or broadcasting of the information or data. A communication system may refer to the collection of individual communication hardware as well as the interconnects associated with and connecting the individual communication hardware. Communication hardware may refer to dedicated communication hardware or may refer to a processor coupled with a communication means (i.e., an antenna) and running software capable of using the communication means to send and/or receive a signal within the communication system. Interconnect refers to some type of wired or wireless communication link that connects various components, such as communication hardware, within a communication system. A communication network may refer to a specific setup of a communication system with the collection of individual communication hardware and interconnects having some definable network topography. A communication network may include wired and/or wireless network having a pre-set to an ad hoc network structure.

The term “computer-readable medium” as used herein refers to any tangible storage and/or transmission medium that participate in providing instructions to a processor for execution. The computer-readable storage medium may be, for example, but not limited to, an electronic, magnetic, optical, electromagnetic, infrared or semiconductor system, apparatus or device or any suitable combination of the foregoing. More specific examples (a non-exhaustive list) of the computer-readable storage medium would include the following: an electrical connection having one or more wires, a portable computer diskette, a hard disk, etc. Such a medium may take many forms, including but not limited to, non-volatile media, volatile media and transmission media. Non-volatile media includes, for example, Non-Volatile Random-Access Memory (NVRAM) or magnetic or optical disks. Volatile media includes dynamic memory, such as main memory. Common forms of computer-readable media include, for example, a floppy disk, a flexible disk, a hard disk, a magnetic tape or any other magnetic medium, magneto-optical medium, a Compact Disk-Read Only Memory (CD-ROM), any other optical medium, punch cards, a paper tape, any other physical medium with patterns of holes, a RAM, a Programmable ROM (PROM), an Erasable PROM (EPROM), a Flash-EPROM, a solid state medium like a memory card, any other memory chip or cartridge, a carrier wave as described hereinafter or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented and/or the like. Accordingly, the disclosure is considered to include a tangible storage medium or distribution medium and prior art-recognized equivalents and successor media, in which the software implementations of the present disclosure are stored.

A “computer readable signal” medium may include a propagated data signal with computer readable program code embodied therein, for example, in baseband or as part of a carrier wave. Such a propagated signal may take any of a variety of forms, including, but not limited to, electro-magnetic, optical or any suitable combination thereof. A computer readable signal medium may be any computer readable medium that is not a computer readable storage medium and that can communicate, propagate or transport a program for use by or in connection with an instruction execution system, apparatus or device. Program code embodied on a computer readable medium may be transmitted using any appropriate medium, including but not limited to wireless, wireline, optical fiber cable, radio-frequency (RF), etc. or any suitable combination of the foregoing.

A “database” is an organized collection of data held in a computer. The data is typically organized to model relevant aspects of reality (for example, the availability of specific types of inventories), in a way that supports processes requiring this information (for example, finding a specified type of inventory). The organization schema or model for the data can, for example, be hierarchical, network, relational, entity-relationship, object, document, XML, entity-attribute-value model, star schema, object-relational, associative, multidimensional, multi-value, semantic and other database designs. Database types include, for example, active, cloud, data warehouse, deductive, distributed, document-oriented, embedded, end-user, federated, graph, hypertext, hypermedia, in-memory, knowledge base, mobile, operational, parallel, probabilistic, real-time, spatial, temporal, terminology-oriented and unstructured databases. Database management system (DBMS)s are specially designed applications that interact with the user, other applications, and the database itself to capture and analyze data.

The terms “determine”, “calculate” and “compute” and variations thereof, are used interchangeably and include any type of methodology, process, mathematical operation or technique.

The term “electronic address” refers to any contactable address, including a telephone number, instant message handle, e-mail address, Universal Resource Locator (URL), Universal Resource Identifier (URI), Address of Record (AOR), electronic alias in a database, like addresses and combinations thereof.

An “enterprise” refers to a business and/or governmental organization, such as a corporation, partnership, joint venture, agency, military branch and the like.

A geographic information system (GIS) is a system to capture, store, manipulate, analyze, manage and present all types of geographical data. A GIS can be thought of as a system—it digitally makes and “manipulates” spatial areas that may be jurisdictional, purpose or application-oriented. In a general sense, GIS describes any information system that integrates, stores, edits, analyzes, shares and displays geographic information for informing decision making.

The terms “instant message” and “instant messaging” refer to a form of real-time text communication between two or more people, typically based on typed text. Instant messaging can be a communication event.

The term “internet search engine” refers to a web search engine designed to search for information on the World Wide Web and File Transfer Protocol (FTP) servers. The search results are generally presented in a list of results often referred to as Search Engine Results Pages (SERPS). The information may consist of web pages, images, information and other types of files. Some search engines also mine data available in databases or open directories. Web search engines work by storing information about many web pages, which they retrieve from the html itself. These pages are retrieved by a Web crawler (sometimes also known as a spider)—an automated Web browser which follows every link on the site. The contents of each page are then analyzed to determine how it should be indexed (for example, words are extracted from the titles, headings, or special fields called meta tags). Data about web pages are stored in an index database for use in later queries. Some search engines, such as Google™, store all or part of the source page (referred to as a cache) as well as information about the web pages, whereas others, such as AltaVista™, store every word of every page they find.

The term “means” as used herein shall be given its broadest possible interpretation in accordance with 35 U.S.C., Section 112, Paragraph 6. Accordingly, a claim incorporating the term “means” shall cover all structures, materials or acts set forth herein, and all of the equivalents thereof. Further, the structures, materials or acts and the equivalents thereof shall include all those described in the summary of the invention, brief description of the drawings, detailed description, abstract and claims themselves.

The term “module” as used herein refers to any known or later developed hardware, software, firmware, artificial intelligence, fuzzy logic or combination of hardware and software that is capable of performing the functionality associated with that element.

A “server” is a computational system (e.g., having both software and suitable computer hardware) to respond to requests across a computer network to provide, or assist in providing, a network service. Servers can be run on a dedicated computer, which is also often referred to as “the server”, but many networked computers are capable of hosting servers. In many cases, a computer can provide several services and have several servers running. Servers commonly operate within a client-server architecture, in which servers are computer programs running to serve the requests of other programs, namely the clients. The clients typically connect to the server through the network but may run on the same computer. In the context of IP networking, a server is often a program that operates as a socket listener. An alternative model, the peer-to-peer networking module, enables all computers to act as either a server or client, as needed. Servers often provide essential services across a network, either to private users inside a large organization or to public users via the Internet.

The term “sound” or “sounds” as used herein refers to vibrations (changes in pressure) that travel through a gas, liquid or solid at various frequencies. Sound(s) can be measured as differences in pressure over time and include frequencies that are audible and inaudible to humans and other animals. Sound(s) may also be referred to as frequencies herein.

The terms “audio output level” and “volume” are used interchangeably and refer to the amplitude of sound produced when applied to a sound producing device.

The term “multi-party” as used herein may refer to communications involving at least two parties. Examples of multi-party calls may include, but are in no way limited to, person-to-person calls, telephone calls, conference calls, communications between multiple participants and the like.

The terms “voice characteristics”, “voice attributes”, and “voice qualities” are used interchangeably and refer to the features found in a person's voice.

The term “artificial intelligence” (AI), as used herein, generally refers to machine intelligence that includes a computer model or algorithm that may be used to provide actionable insight, make a prediction, and/or control actuators. The AI may be a machine learning algorithm. The machine learning algorithm may be a trained machine learning algorithm, e.g., a machine learning algorithm trained from data. Such a trained machine learning algorithm may be trained using supervised, semi-supervised, or unsupervised learning processes. Examples of machine learning algorithms include neural networks, support vector machines and reinforcement learning algorithms.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit”, “module” or “system”. Any combination of one or more computer readable medium(s) may be utilized. The computer readable medium may be a computer readable signal medium or a computer readable storage medium.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300 and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARIVI926EJ-S™ processors, other industry-equivalent processors, and may perform computational functions using any known or future-developed standard, instruction set, libraries and/or architecture.

The ensuing description provides embodiments only and is not intended to limit the scope, applicability or configuration of the claims. Rather, the ensuing description will provide those skilled in the art with an enabling description for implementing the embodiments. It will be understood that various changes may be made in the function and arrangement of elements without departing from the spirit and scope of the appended claims.

Any reference in the description including an element number, without a sub element identifier when a sub element identifier exists in the figures, when used in the plural, is intended to reference any two or more elements with a like element number. When such a reference is made in the singular form, it is intended to reference one of the elements with the like element number without limitation to a specific one of the elements. Any explicit usage herein to the contrary or providing further qualification or identification shall take precedence.

The exemplary systems and methods of this disclosure will also be described in relation to analysis software, modules and associated analysis hardware. However, to avoid unnecessarily obscuring the present disclosure, the following description omits well-known structures, components, and devices, which may be omitted from or shown in a simplified form in the figures or otherwise summarized.

For purposes of explanation, numerous details are set forth in order to provide a thorough understanding of the present disclosure. It should be appreciated, however, that the present disclosure may be practiced in a variety of ways beyond the specific details set forth herein.

The preceding is a simplified summary of the disclosure to provide an understanding of some aspects of the disclosure. This summary is neither an extensive nor exhaustive overview of the disclosure and its various aspects, embodiments and/or configurations. It is intended neither to identify key or critical elements of the disclosure nor to delineate the scope of the disclosure but to present selected concepts of the disclosure in a simplified form as an introduction to the more detailed description presented below. As will be appreciated, other aspects, embodiments and/or configurations of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

### BRIEF DESCRIPTION OF THE DRAWINGS

The present disclosure will be described in conjunction with the appended figures.

FIG. 1 is a block diagram of an illustrative communication system used for filtering extraneous voices during a communication session according to embodiments of the present disclosure.

FIG. 2 is a block diagram of an illustrative conferencing server provided in a communication system used for voice attribute manipulation during a communication session according to embodiments of the present disclosure.

FIG. 3 is a block diagram of an illustrative communication device provided in a communication system used for voice attribute manipulation during a communication session according to embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the embodiments. Various changes may be made in the function and arrangement of elements without departing from the spirit and scope of the present disclosure.

When a user uses a telecommunication device in a noisy environment where many people are talking (e.g., a contact center), the far-end party may hear voices other than the voice of the person who is using the device. In an illustrative example, in the late 1980s, on the trading floor of the New York Stock Exchange, trading specialists often stood in close proximity to each other and customers of Specialist A were able to hear what Specialist B was saying to B's customers. The problem at the New York Stock Exchange was addressed by configuring turrets with highly directional Confidencer® microphones that filtered out sounds and voices originating from off-axis locations.

A later solution tried to address the problem with a modified version of the “Type R” handset that attempted to filter-out background noise by automatically attenuating the signal from the microphone by 20 dB when the input dropped below a predefined level (the assumption being that the user was not speaking, and therefore anything picked up by the microphone would be undesirable).

Both of these solutions rely on expensive hardware that needs to be installed at every workstation, and comes with their own sets of problems. For example, the Confidencer® microphones that were installed at the New York Stock Exchange did not work correctly if they were not positioned directly in front of the user's mouth. In the modified “Type R” handsets, the attenuator circuit would engage and disengage inappropriately when the background noise level was close to the level that would trigger the attenuator. Putting the attenuator mechanism in the network instead of in the handset was not feasible because modem communication would have been harmed.

A reliable software solution, especially one that can be installed on a shared server instead of needing to be installed on workstations individually, is an economically attractive alternative. This disclosure utilizes reliable speaker identification techniques and a short-duration first-in, first-out (FIFO) buffer that allows undesirable voices to be removed prior to transmitting the audio to the far-end party. The physical characteristics of human speech used to determine who is speaking, include the fundamental pitch (also referred to as the excitation frequency), the locations of the vocal tract resonances (also referred to as the formant structure), prosody, and accent. In embodiments, the system may be trained to identify voices in the FIFO buffer in which the vocal tract resonances (i.e., the formant structures) correspond to those of the intended user (e.g., the user associated with the communication device), and filter-out voices that do not have those resonant characteristics. The system does not need to identify the speakers associated with the extraneous voices, only that the voices should not be transmitted to the far-end party.

In most telecommunication scenarios, it would be unacceptable to have a time delay of a few seconds between when Party A speaks and when Party B hears Party A's voice. However, in a contact center environment, time delays may not be unusual or unexpected when a contact center agent is speaking to a customer, often because the agent is searching for an answer to the customer's question or because the agent is communicating with another customer and is going back-and-forth between the two customers. In addition, there can be transmission delays when the customer and agent are on opposite sides of the world. Assuming that it would be acceptable to have a short delay between when the agent speaks and when the customer hears the agent's response, the method of the present disclosure would work in the following manner: (1) the audio signal received from the agent's microphone does not go instantly to the far-end party, but instead goes into a short-duration FIFO buffer; (2) the audio recording in the FIFO buffer is analyzed using automatic speaker identification techniques; (3) voice signals that are identified as coming from the desired speaker are retained while other voices are filtered out; and (4) the filtered output of the FIFO buffer is what gets transmitted to the far-end party.

Advantages of the present disclosure include: (1) ease of implementation, the method of the present disclosure can be implemented in workstations individually or in a shared server (e.g., Avaya Communication Manager system); (2) the method can easily be turned on/off (e.g., the buffer mechanism could be bypassed automatically, and transmissions become immediate, when the system determines that background voices are not present or not loud enough to make a difference or if certain types of non-voice media, such as TTY modem signals, are detected); (3) the length of the buffer (e.g., two seconds vs three seconds) could be adjusted automatically, balancing the accuracy of the undesired voice removal against the annoyance of having time delays that are longer than necessary; (4) the processes described above as “automatic” could be controlled manually, either by the user who is in the noisy location or by a far-end user who is hearing the background voices. For example, looking at embodiment #2, a far-end user who is annoyed by the delay but is willing to hear background voices could send a command to the noisy user's system, instructing it to stop using the buffer. A preferred implementation of this idea would notify the noisy location user about the settings selected by the far-end user.

Embodiments of the present disclosure include a method including receiving, via a microphone of a communication device, an audio stream associated with a communication session, wherein the audio stream is stored in a FIFO buffer; processing the audio stream from the FIFO buffer to generate a filtered audio stream where a voice of a user associated with the communication device is retained and voices other than the voice of the user associated with the communication device are removed; and transferring the filtered audio stream to another party of the communication session.

Embodiments of the present disclosure include a system including one or more processors and a memory coupled with and readable by the one or more processors and having stored therein a set of instructions which, when executed by the one or more processors, causes the one or more processors to receive, via a microphone of a communication device, an audio stream associated with a communication session, wherein the audio stream is stored in a FIFO buffer; process the audio stream from the FIFO buffer to generate a filtered audio stream where a voice of a user associated with the communication device is retained and voices other than the voice of the user associated with the communication device are removed; and transfer the filtered audio stream to another party of the communication session.

Embodiments of the present disclosure include computer readable medium including microprocessor executable instructions that, when executed by the microprocessor, perform the functions of receive, via a microphone of a communication device, an audio stream associated with a communication session, wherein the audio stream is stored in a FIFO buffer; process the audio stream from the FIFO buffer to generate a filtered audio stream where a voice of a user associated with the communication device is retained and voices other than the voice of the user associated with the communication device are removed; and transfer the filtered audio stream to another party of the communication session.

Any of the aspects herein including receiving a voice sample of the voice of the user associated with the communication device, wherein the audio stream is processed using speaker identification techniques and the voice sample of the voice of the user.

Any of the aspects herein including determining a noise level in the audio stream; and bypassing the FIFO buffer and directly transferring the audio stream to the other party of the communication session when the noise level of the audio stream is below a threshold.

Any of the aspects herein including bypassing the FIFO buffer and directly transferring the audio stream to the other party of the communication session if annoyance is detected from the other party of the communication session.

Any of the aspects herein including bypassing the FIFO buffer and directly transferring the audio stream to the other party of the communication session when non-voice media is detected in the audio stream.

Any of the aspects herein including providing the other party of the communication session an option to reduce a delay associated with receiving the filtered audio stream; receiving an input from the other party of the communication session indicating a selection of the option to reduce the delay associated with receiving the filtered audio stream; and bypassing the FIFO buffer and directly transferring the audio stream to the other party of the communication session.

Any of the aspects herein including notifying the user associated with the communication device that the other party of the communication session has selected to reduce the delay associated with receiving the filtered audio stream and that the FIFO buffer is bypassed and the audio stream is transferred directly to the other party of the communication session.

Any of the aspects herein including determining a delay between when the user speaks and when the other party of the communication session receives the filtered audio stream; and bypassing the FIFO buffer and directly transferring the audio stream to the other party of the communication session when the delay between when the user speaks and when the other party of the communication session receives the filtered audio stream is above a threshold.

Any of the aspects herein wherein the method is stored on a server associated with the communication device.

Any of the aspects herein including the method is stored on a server associated with the communication session.

Any aspect in combination with any one or more other aspects.

Any one or more of the features disclosed herein.

Any one or more of the features as substantially disclosed herein.

Any one or more of the features as substantially disclosed herein in combination with any one or more other features as substantially disclosed herein.

Any one of the aspects/features/embodiments in combination with any one or more other aspects/features/embodiments.

Use of any one or more of the aspects or features as disclosed herein.

It is to be appreciated that any feature described herein can be claimed in combination with any other feature(s) as described herein, regardless of whether the features come from the same described embodiment.

The details of one or more aspects of the disclosure are set forth in the accompanying drawings and the description below. Other features, objects, and advantages of the techniques described in this disclosure will be apparent from the description and drawings, and from the claims.

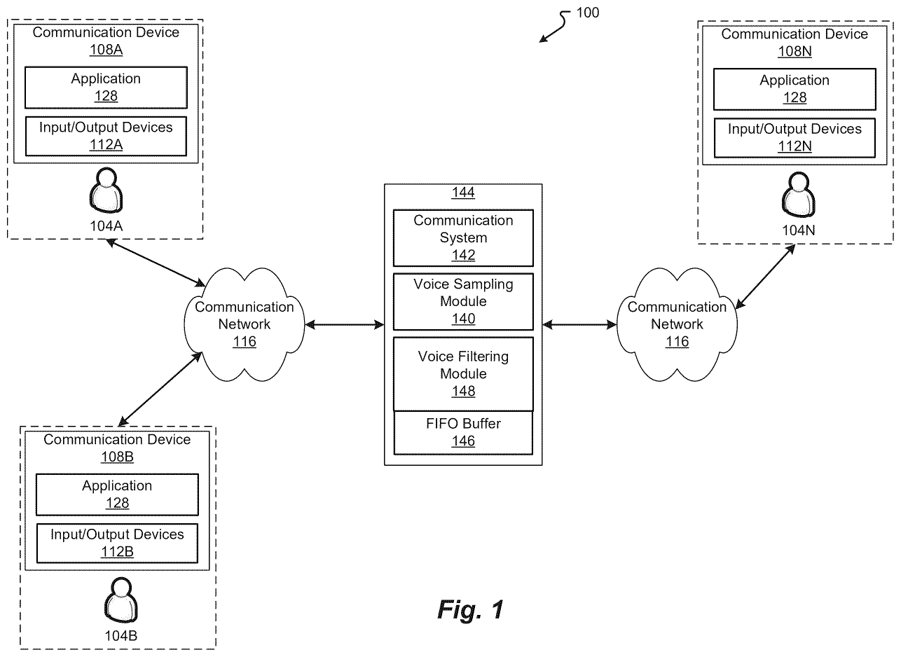

FIG. 1 is a block diagram of an illustrative communication system 100 used for voice filtering during a communication session according to embodiments of the present disclosure. Referring to FIG. 1, the communication system 100 is illustrated in accordance with at least one embodiment of the present disclosure. The communication system 100 may allow a user 104A to participate in the communication system 100 using a communication device 108A having an input/output device 112A and an application 128. As used herein, the communication devices include user devices. Other users 104B to 104N can also participate in the communication system 100 using respective communication devices 108B through 108N having input/output devices 112B to 112N and applications 128.

As discussed in greater detail below, the input/output devices 112A to 112N, may include one or more audio input devices, audio output devices, video input devices and/or video output devices. In some embodiments of the present disclosure, the audio input/output devices 112A-112N may be separate from the communication devices 108A-108N. For example, an audio input device may include, but is not limited to, a receiver microphone used by the communication device 108A, as part of the communication device 108A and/or an accessory (e.g., a headset, etc.) to convey audio to one or more of the other communication devices 108 and the communication system 142. In some cases, the audio output device may include, but is not limited to speakers, which are part of a headset, standalone speakers or speakers integrated into the communication devices 108A-108N.

Video input devices, such as cameras may correspond to an electronic device capable of capturing and/or processing an image and/or a video content. The cameras may include suitable logic, circuitry, interfaces and/or code that may be operable to capture and/or process an image and/or a video content.

The communication network 116 may be packet-switched and/or circuit-switched. An illustrative communication network 116 includes, without limitation, a Wide Area Network (WAN), such as the Internet, a Local Area Network (LAN), a Personal Area Network (PAN), a Public Switched Telephone Network (PSTN), a Plain Old Telephone Service (POTS) network, a cellular communications network, an Internet Protocol Multimedia Subsystem (IMS) network, a Voice over Internet Protocol (VoIP) network, a Session Initiated Protocol (SIP) network or combinations thereof. The Internet is an example of the communication network 116 that constitutes an Internet Protocol (IP) network including many computers, computing networks, and other communication devices located all over the world, which are connected through many telephone systems and other means. In one configuration, the communication network 116 is a public network supporting the User Datagram Protocol (UDP). Communications supported by the communication network 116 include real-time, near-real-time, and non-real-time communications. For instance, the communication network 116 may support voice, video, text, web-conferencing, or any combination of media. Moreover, the communication network 116 may include a number of different communication media such as coaxial cable, copper cable/wire, fiber-optic cable, antennas for transmitting/receiving wireless messages and combinations thereof. In addition, it can be appreciated that the communication network 116 need not be limited to any one network type, and instead may include a number of different networks and/or network types. It should be appreciated that the communication network 116 may be distributed. Although embodiments of the present disclosure will refer to one communication network 116, it should be appreciated that the embodiments of the present disclosure claimed herein are not so limited. For instance, more than one communication network 116 may be joined by combinations of servers and networks.

The term “communication device” as used herein is not limiting and may be referred to as a user device and mobile device, and variations thereof. A communication device, as used herein, may include any type of device capable of communicating with one or more other device and/or across a communications network, via a communications protocol and the like. A communication device may include any type of known communication equipment or collection of communication equipment. Examples of an illustrative communication device may include, but are not limited to, any device with a sound and/or pressure receiver, a cellular phone, a smart phone, a telephone, handheld computers, laptops, netbooks, notebook computers, subnotebooks, tablet computers, scanners, portable gaming devices, pagers, Global Positioning System (GPS) modules, portable music players and other sound and/or pressure receiving devices. A communication device does not have to be Internet-enabled and/or network-connected. In general, each communication device may provide many capabilities to one or more users who desire to use or interact with the communication system 142. For example, a user may access the communication system 142 utilizing the communication network 116. For example, User 104A may be a customer communicating with the User N (e.g., contact center agent) via the server 144. Although the examples described herein include a user communicating with a contact center, it is understood that the present disclosure may be applied to any communication session including extraneous voices/noise.

Capabilities enabling the disclosed systems and methods may be provided by one or more communication devices through hardware or software installed on the communication device, such as the application 128. For example, the application 128 may be in the form of a communication application and can be used to manipulate the voice attributes of a speaker during a communication session. Capabilities enabling the disclosed systems and methods may be provided by the server 144.

In some embodiments of the present disclosure, the communication system 142 may reside within a server 144. The server 144 may be a server that is administered by an enterprise associated with a contact center, or the server 144 may be an external server that can be administered by a third-party service, meaning that the entity which administers the external server is not the same entity that either owns or administers the contact center. As illustrated in FIG. 1, the server 144 includes a communication system 142, a voice sampling module 140, a voice filtering module 148 and a FIFO buffer 146.

Although various modules and data structures for the disclosed systems and methods are depicted as residing on the server 144, one skilled in the art can appreciate that one, some, or all of the depicted components of the server 144 may be provided by other software or hardware components. For example, one, some, or all of the depicted components of the server 144 may be provided by logic on a communication device (e.g., the communication device may include logic for the systems and methods disclosed herein so that the systems and methods are performed locally at the communication device). Further, the logic of application 128 can be provided on the server 144 (e.g., the server 144 may include logic for the systems and methods disclosed herein so that the systems and methods are performed at the server 144). In embodiments of the present disclosure, the server 144 can perform the methods disclosed herein without use of logic on any of the communication devices 108A-108N.

The communication system 142 implements functionality for the systems and methods described herein by interacting with two or more of the communication devices 108A-108N, the application 128, the voice sampling module 140, the voice filtering module 148 and the FIFO buffer 146 and/or other sources of information as discussed in greater detail below that can allow two or more communication devices 108 to participate in a communication session.

In some embodiments of the present disclosure the voice filtering module 148 can also be part of the application 128 executing on the user's communication device 108. One example of a communication session includes, but is not limited to, a person-to-person call, a conference call between two or more users/parties and the like. Although some embodiments of the present disclosure are discussed in connection with contact center communications, embodiments of the present disclosure are not so limited. Specifically, the embodiments disclosed herein may be applied to any audio communication, video communication, multimedia communication, conference calls, web conferences and the like.

In some embodiments of the present disclosure, the communication system 142 can include one or more resources such as the voice sampling module 140 as discussed in greater detail below. As can be appreciated, the resources of the communication system 142 may depend on the type of communication session provided by the communication system 142. Among other things, the communication system 142 may be configured to provide communication sessions of at least one media type between any number of the participants.

In some embodiments of the present disclosure, the voice filtering module 148 is used to identify a specific user's 104 voice in order to isolate and retain the user's 104 voice in an audio stream. This is accomplished by receiving a voice sample of a natural voice of the one or more of the users 104A-104N and analyzing the voice sample of the one or more of the users 104A-104N for attributes of the voice sample using the voice sampling module 140. As discussed in greater detail below, the voice filtering module 148 may include several components, including an audio analyzer, a voice recorder, an artificial intelligence module and a voice attribute manipulation module as discussed in greater detail below.

The length of the FIFO buffer (e.g., two seconds vs three seconds) may be adjusted automatically, balancing the accuracy of the undesired voice removal against the annoyance of having time delays that are longer than necessary.

The application 128 may be executed by one or more of the communication devices (e.g., the communication devices 108A-108N) and may execute all or part of the communication system 142 at one or more of the communication devices 108A-108N.

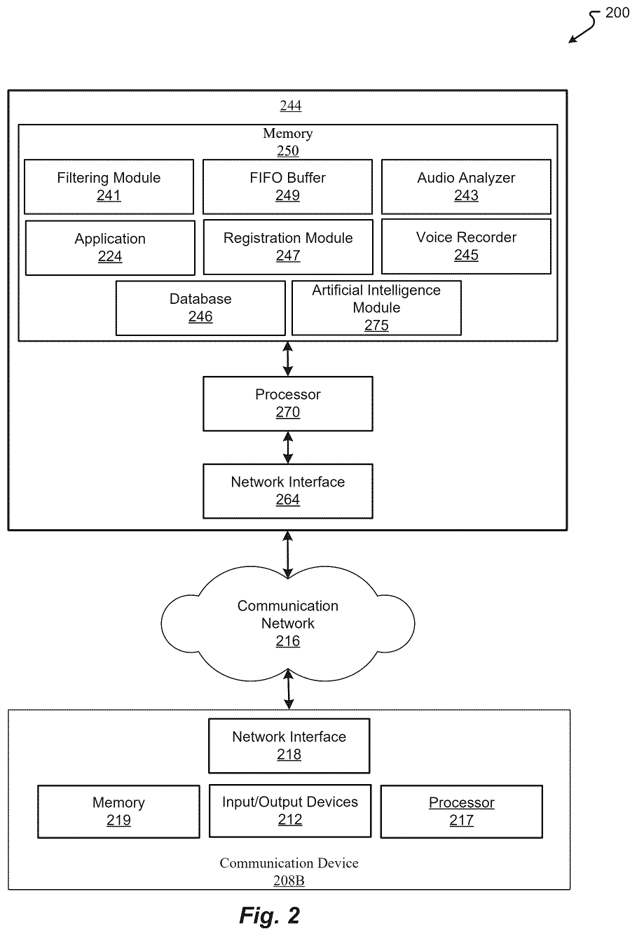

FIG. 2 is a block diagram of an illustrative server 244 provided in a communication system 200 used for filtering extraneous noise during a communication session according to embodiments of the present disclosure. Referring to FIG. 2, the communication system 200 is illustrated in accordance with at least one embodiment of the present disclosure. The communication system 200 may allow user(s) to participate in a communication sessions with other users. The server 244 implements functionality establishing the communication session for the systems and methods described herein by interacting with the communication devices (including its hardware and software components) and the various components of the server 244. For example, the server 244 includes a memory 250 and a processor 270. Furthermore, the server 244 includes a network interface 264. The memory 250 includes a database 246, an application 224 (used in conjunction with the application 128 of the communication devices 108A-108N), FIFO buffer 249, an audio analyzer 243, a voice recorder 245, a registration module 247, a voice filtering module 241 and an artificial intelligence module 275.

The processor 270 may include a microprocessor, a Central Processing Unit (CPU), a collection of processing units capable of performing serial or parallel data processing functions and the like. The memory 250 may include a number of applications or executable instructions that are readable and executable by the processor 270. For example, the memory 250 may include instructions in the form of one or more modules and/or applications such as application 224. The memory 250 may also include data and rules in the form of settings that can be used by one or more of the modules and/or applications described herein. The memory 250 may also include one or more communication applications and/or modules, which provide communication functionality of the server 244. In particular, the communication application(s) and/or module(s) may contain the functionality necessary to enable the server 244 to communicate with communication device 208B as well as other communication devices (not shown) across the communication network 216.

Among other things, the memory 250 may be used to store instructions, that when executed by the processor 270 of the communication system 200, perform the methods as provided herein. In some embodiments of the present disclosure, one or more of the components of the communication system 200 may include a memory. In one example, each component in the communication system 200 may have its own memory. Continuing this example, the memory 250 may be a part of each component in the communication system 200. In some embodiments of the present disclosure, the memory 250 may be located across the communication network 216 for access by one or more components in the communication system 200. In any event, the memory 250 may be used in connection with the execution of application programming or instructions by the processor 270, and for the temporary or long-term storage of program instructions and/or data. As examples, the memory 250 may include Random-Access Memory (RAM), Dynamic RAM (DRAM), Static RAM (SDRAM) or other solid-state memory. Alternatively, or in addition, the memory 250 may be used as data storage and can include a solid-state memory device or devices. Additionally, or alternatively, the memory 250 used for data storage may include a hard disk drive or other random-access memory. In some embodiments of the present disclosure, the memory 250 may store information associated with a user, a timer, rules, recorded audio information, recorded video information and the like. For instance, the memory 250 may be used to store predetermined speech characteristics, private conversation characteristics, video characteristics, information related to mute activation/deactivation, times associated therewith, combinations thereof and the like.

The network interface 264 includes components for connecting the server 244 to the communication network 216. In some embodiments of the present disclosure, a single network interface 264 connects the server 244 to multiple networks. In some embodiments of the present disclosure, a single network interface 264 connects the server 244 to one network and an alternative network interface is provided to connect the server 244 to another network. The network interface 264 may include a communication modem, a communication port or any other type of device adapted to condition packets for transmission across the communication network 216 to one or more destination communication devices (not shown), as well as condition received packets for processing by the processor 270. Examples of network interfaces include, without limitation, a network interface card, a wireless transceiver, a modem, a wired telephony port, a serial or parallel data port, a radio frequency broadcast transceiver, a Universal Serial Bus (USB) port or other wired or wireless communication network interfaces.

The type of network interface 264 utilized may vary according to the type of network to which the server 244 is connected. Exemplary communication networks 216 to which the server 244 may connect via the network interface 264 include any type and any number of communication mediums and devices which are capable of supporting communication events (also referred to as “phone calls”, “messages”, “communications” and “communication sessions” herein), such as voice calls, video calls, chats, e-mails, Teletype (TTY) calls, multimedia sessions or the like. In situations where the communication network 216 is composed of multiple networks, each of the multiple networks may be provided and maintained by different network service providers. Alternatively, two or more of the multiple networks in the communication network 216 may be provided and maintained by a common network service provider or a common enterprise in the case of a distributed enterprise network.

The voice recorder 245 records voice samples of the user. The voice samples can be previously stored in database 246 or registration module 247 for future use.

The audio analyzer 243 is also used to identify voice attributes of the recorded voice sample. The voice attributes may include but are not limited to a pitch, a tone, a volume, an intensity, a vocal fry, a rhythm, a texture, an intonation, the fundamental pitch of the voice (also referred to as the excitation frequency) and the locations of the vocal tract resonances (also referred to as the formant structure), etc. According to embodiments of the present disclosure, the speech of each of the participants is represented as a waveform. This waveform is captured in a sound format, such as, but not limited to Audio Video Interleaved (AVI), Motion Picture Experts Group-1 Audio Layer-3 (MP3), etc. by the audio analyzer 243 using the artificial intelligence module 275. The user-identifying voiceprint is derived from a time-by-frequency-by-intensity spectroscopic analysis of the waveform.

The artificial intelligence module 275 uses a machine learning model that can be applied to the voice samples to identify specific speakers.

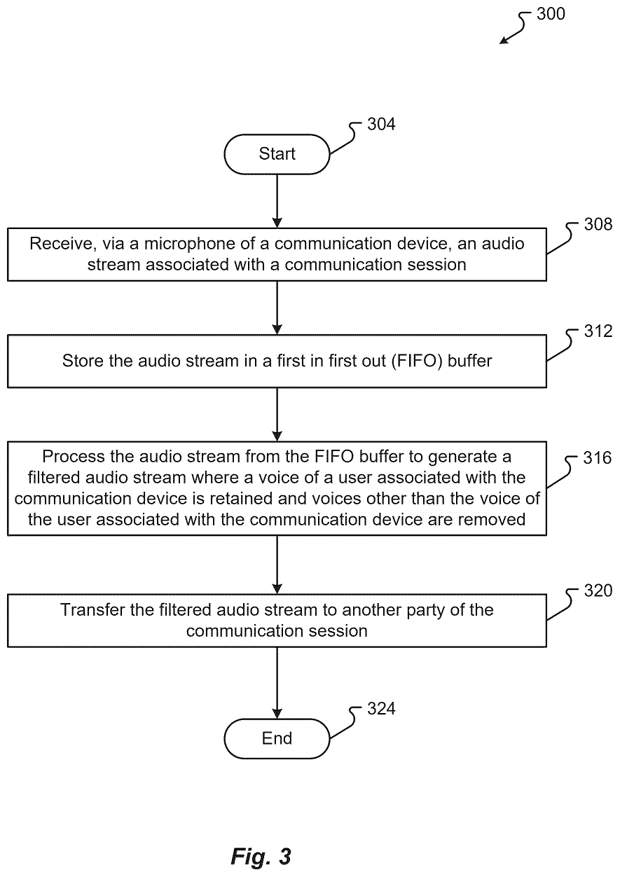

The communication system 200 further includes the communication device 208B which includes the network interface 218, the processor 217, the memory 219 including at least the application 128 and the input/output device 212. A detailed description of the communication device 208B is provided in FIG. 3.

FIG. 3 is a flow diagram of a method 300 used for removing extraneous voices from a communication session according to embodiments of the present disclosure. While a general order of the steps of method 300 is shown in FIG. 3, method 300 can include more or fewer steps or can arrange the order of the steps differently than those shown in FIG. 3. Further, two or more steps may be combined into one step. Generally, method 300 starts with a START operation at step 304 and ends with an END operation at step 324. Method 300 can be executed as a set of computer-executable instructions executed by a data-processing system and encoded or stored on a computer readable medium. Hereinafter, method 300 shall be explained with reference to the systems, the components, the modules, the software, the data structures, the user interfaces, etc. described in conjunction with FIGS. 1-2.

Method 300 starts with the START operation at step 304 and proceeds to step 308, where an audio stream is received, via a microphone of a communication device. For example, the contact agent speaks into his microphone and that audio stream is transferred to the server 144. After receiving the audio stream of the user at step 308, method 300 proceeds to step 312, where the audio stream is stored in a FIFO buffer (e.g., the FIFO buffer 146). At step 316 the audio stream in the FIFO buffer is processed to generate a filtered audio stream where a voice of a user associated with the communication device is retained and voices other than the voice of the user associated with the communication device are removed. For example the voice of the intend user may be identified by analyzing the audio stream to identify user-specific physical attributes of the intended user's voice, including but not limited to the fundamental pitch and locations of the vocal tract resonances. At step 320 the filtered audio stream is transferred to another party of the communication session. For example, the contact center agent's audio stream is filtered to remove extraneous noise (e.g., voices) and the filtered audio stream is transferred to the customer that has called the contact center. The method 300 ends with END operation at step 324.

In embodiments, the steps 312 and 316 may be skipped. For example, if the noise level of an audio stream is below a threshold (e.g., a quiet environment) the filtering may be unnecessary, and the audio stream may be directly transferred to the other party of the communication session. In another example, if it is detected that the other party of the communication session is annoyed by the delay caused by filtering the audio stream to remove extraneous noise, the voice filtering feature may be turned off. For example, the tone or speech of the other party may be analyzed to determine if the other party is annoyed with the delay caused by filtering the audio stream. The other party may be provided with an option to turn off voice filtering, or enter an input (e.g., audible request, touch tone input, etc.) that indicates selection of receiving an audio stream without filtering. In embodiments, when the other party selects to bypass voice filtering, the other user will be notified of the selection. In another example, the audio stream may comprise non-voice media (e.g., TTY modem signals) and voice filtering is unnecessary and may be bypassed. In yet another example, the voice filtering feature may be turned off when a delay between when the user speaks and when the other party of the communication session receives the filtered audio stream exceeds a threshold.

The exemplary systems and methods of this disclosure have been described in relation to a distributed processing network. However, to avoid unnecessarily obscuring the present disclosure, the preceding description omits a number of known structures and devices. This omission is not to be construed as a limitation of the scopes of the claims. Specific details are set forth to provide an understanding of the present disclosure. It should however be appreciated that the present disclosure may be practiced in a variety of ways beyond the specific detail set forth herein.

Furthermore, while the exemplary aspects, embodiments and/or configurations illustrated herein show the various components of the system collocated, certain components of the system can be located remotely, at distant portions of a distributed network, such as a LAN and/or the Internet or within a dedicated system. Thus, it should be appreciated that the components of the system can be combined into one or more devices, such as a server, or collocated on a particular node of a distributed network, such as an analog and/or digital communications network, or a packet-switch network or a circuit-switched network. It will be appreciated from the preceding description and for reasons of computational efficiency, that the components of the system can be arranged at any location within a distributed network of components without affecting the operation of the system. For example, the various components can be located in a switch such as a Privat Branch Exchange (PBX) and media server, gateway, in one or more communications devices, at one or more users' premises or some combination thereof. Similarly, one or more functional portions of the system could be distributed between a communications device(s) and an associated computing device.

Furthermore, it should be appreciated that the various links connecting the elements can be wired or wireless links, or any combination thereof or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics and may take the form of acoustic or light waves, such as those generated during radio-wave and infrared data communications.

Also, while the flowcharts have been discussed and illustrated in relation to a particular sequence of events, it should be appreciated that changes, additions and omissions to this sequence can occur without materially affecting the operation of the disclosed embodiments, configuration and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as Programmable Logic Device (PLD), Programmable Logic Array (PLA), Field Programmable Gate Array (FPGA), Programmable Array Logic (PAL) special purpose computer, any comparable means or the like. In general, any device(s) or means capable of implementing the methodology illustrated herein can be used to implement the various aspects of this disclosure. Exemplary hardware that can be used for the disclosed embodiments, configurations and aspects includes computers, handheld devices, telephones (e.g., cellular, Internet enabled, digital, analog, hybrids and others), and other hardware known in the art. Some of these devices include processors (e.g., a single or multiple microprocessors), memory, nonvolatile storage, input devices and output devices. Furthermore, alternative software implementations including, but not limited to, distributed processing or component/object distributed processing, parallel processing or virtual machine processing can also be constructed to implement the methods described herein.

In yet another embodiment of the present disclosure, the disclosed methods may be readily implemented in conjunction with software using object or object-oriented software development locations that provide portable source code that can be used on a variety of computer or workstation platforms. Alternatively, the disclosed system may be implemented partially or fully in hardware using standard logic circuits or Very Large-scale Integration (VLSI) design. Whether software or hardware is used to implement the systems in accordance with this disclosure is dependent on the speed and/or efficiency requirements of the system, the particular function and the particular software or hardware systems or microprocessor or microcomputer systems being utilized.

In yet another embodiment of the present disclosure, the disclosed methods may be partially implemented in software that can be stored on a storage medium, executed on programmed general-purpose computer with the cooperation of a controller and memory, a special purpose computer, a microprocessor or the like. In these instances, the systems and methods of this disclosure can be implemented as program embedded on personal computer such as an applet, JAVA® or Computer-generated Imagery (CGI) script, as a resource residing on a server or computer workstation, as a routine embedded in a dedicated measurement system, system component or the like. The system can also be implemented by physically incorporating the system and/or method into a software and/or hardware system.

Although the present disclosure describes components and functions implemented in the aspects, embodiments and/or configurations with reference to particular standards and protocols, the aspects, embodiments and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments and/or configurations, includes components, methods, processes, systems and/or apparatus substantially as depicted and described herein, including various aspects, embodiments, configurations embodiments, sub combinations and/or subsets thereof. Those of skill in the art will understand how to make and use the disclosed aspects, embodiments and/or configurations after understanding the present disclosure. The present disclosure, in various aspects, embodiments and/or configurations, includes providing devices and processes in the absence of items not depicted and/or described herein or in various aspects, embodiments and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments and/or configurations for the purpose of streamlining the disclosure. The features of the aspects, embodiments and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment and/or configuration. Thus, the following claims are hereby incorporated into this Detailed Description, with each claim standing on its own as a separate preferred embodiment of the disclosure.

Moreover, though the description has included description of one or more aspects, embodiments and/or configurations and certain variations and modifications, other variations, combinations and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein and without intending to publicly dedicate any patentable subject matter.

What is claimed is:

1. A method, comprising:
receiving, via a microphone of a communication device, an audio stream associated with a communication session, wherein the audio stream is stored in a first-in, first-out (FIFO) buffer;
processing the audio stream from the FIFO buffer to generate a filtered audio stream where a voice of a user associated with the communication device is retained and voices other than the voice of the user associated with the communication device are removed; and
transferring the filtered audio stream to another party of the communication session.

2. The method of claim 1, further comprising:
receiving a voice sample of the voice of the user associated with the communication device;
processing the voice sample to identify characterizing physical attributes of the voice of the user associated with the communication device; and
deleting from the FIFO buffer voices in which the characterizing physical attributes do not match those of the user associated with the communication device.

3. The method of claim 1, further comprising:
determining a noise level in the audio stream; and
bypassing the FIFO buffer and directly transferring the audio stream to the other party of the communication session when the noise level of the audio stream is below a threshold.

4. The method of claim 1, further comprising:
bypassing the FIFO buffer and directly transferring the audio stream to the other party of the communication session if annoyance is detected from the other party of the communication session.

5. The method of claim 1, further comprising:
bypassing the FIFO buffer and directly transferring the audio stream to the other party of the communication session when non-voice media is detected in the audio stream.

6. The method of claim 1, further comprising:
providing to the other party of the communication session an option to reduce a delay associated with receiving the filtered audio stream;
receiving an input from the other party of the communication session indicating a selection of the option to reduce the delay associated with receiving the filtered audio stream; and
bypassing the FIFO buffer and directly transferring the audio stream to the other party of the communication session.

7. The method of claim 6, further comprising:
notifying the user associated with the communication device that the other party of the communication session has selected to reduce the delay associated with receiving the filtered audio stream and that the FIFO buffer is bypassed and the audio stream is transferred directly to the other party of the communication session.

8. The method of claim 1, further comprising:
determining a delay between when the user speaks and when the other party of the communication session receives the filtered audio stream; and
bypassing the FIFO buffer and directly transferring the audio stream to the other party of the communication session when the delay between when the user speaks and when the other party of the communication session receives the filtered audio stream is above a threshold.

9. The method of claim 1, wherein the method is stored on a server associated with the communication session.

10. A system, comprising:
one or more processors; and
a memory coupled with and readable by the one or more processors and having stored therein a set of instructions which, when executed by the one or more processors, cause the one or more processors to:
receive, via a microphone of a communication device, an audio stream associated with a communication session, wherein the audio stream is stored in a first-in, first-out (FIFO) buffer;
process the audio stream from the FIFO buffer to generate a filtered audio stream where a voice of a user associated with the communication device is retained and voices other than the voice of the user associated with the communication device are removed; and
transfer the filtered audio stream to another party of the communication session.

11. The system of claim 10, wherein the one or more processors are further caused to:
receive a voice sample of the voice of the user associated with the communication device;
identify, based on the voice sample, characterizing physical attributes of the voice of the user associated with the communication device; and
delete from the FIFO buffer voices in which the characterizing physical attributes do not match those of the user associated with the communication device.

12. The system of claim 10, wherein the one or more processors are further caused to:
determine a noise level in the audio stream; and
bypass the FIFO buffer and directly transfer the audio stream to the other party of the communication session when the noise level of the audio stream is below a threshold.

13. The system of claim 10, wherein the one or more processors are further caused to:
bypass the FIFO buffer and directly transfer the audio stream to the other party of the communication session if annoyance is detected from the other party of the communication session.

14. The system of claim 10, wherein the one or more processors are further caused to:
bypass the FIFO buffer and directly transfer the audio stream to the other party of the communication session when non-voice media is detected in the audio stream.

15. The system of claim 10, wherein the one or more processors are further caused to:
provide to the other party of the communication session an option to reduce a delay associated with receiving the filtered audio stream;
receive an input from the other party of the communication session indicating a selection of the option to reduce the delay associated with receiving the filtered audio stream; and
bypass the FIFO buffer and directly transfer the audio stream to the other party of the communication session.

16. The system of claim 15, wherein the one or more processors are further caused to:
notify the user associated with the communication device that the other party of the communication session has selected to reduce the delay associated with receiving the filtered audio stream and that the FIFO buffer is bypassed and the audio stream is transferred directly to the other party of the communication session.

17. The system of claim 10, wherein the one or more processors are further caused to:
determine a delay between when the user speaks and when the other party of the communication session receives the filtered audio stream; and
bypass the FIFO buffer and directly transfer the audio stream to the other party of the communication session when the delay between when the user speaks and when the other party of the communication session receives the filtered audio stream is above a threshold.

18. A computer readable medium comprising microprocessor executable instructions that, when executed by the microprocessor, perform the following functions:
receive, via a microphone of a communication device, an audio stream associated with a communication session, wherein the audio stream is stored in a first-in, first-out (FIFO) buffer;
process the audio stream from the FIFO buffer to generate a filtered audio stream where a voice of a user associated with the communication device is retained and voices other than the voice of the user associated with the communication device are removed; and
transfer the filtered audio stream to another party of the communication session.

19. The computer readable medium of claim 18, wherein the microprocessor further performs:
determining a noise level in the audio stream; and
bypassing the FIFO buffer and directly transferring the audio stream to the other party of the communication session when the noise level of the audio stream is below a threshold.

20. The computer readable medium of claim 18, wherein the microprocessor further performs:
identifying, based on a voice sample from the user associated with the communication device, characterizing physical attributes of the voice of the user associated with the communication device; and
deleting from the FIFO buffer voices in which the characterizing physical attributes do not match those of the user associated with the communication device.
